(19) United States
(12) Patent Application Publication
(10) Pub. No.: US 2008/0312820 A1
(43) Pub. Date: Dec. 18, 2008

(54) Method of driver assignment and scheduling segmented long-haul routes

(76) Inventor: Ajesh Kapoor, Atlanta, GA (US)

Correspondence Address: Hill, Kertscher & Wharton, LLP, Suite 800, 3350 Riverwood Parkway, Atlanta, GA, 30339, US

(21) Appl. No.: 11/818,180

(22) Filed: Jun. 14, 2007

(51) Int. Cl. G01C 21/00

(52) U.S. Cl. 701/202

(57) ABSTRACT

A method for creating segmented routes for long-haul truck drivers to reduce the driving times of the drivers while maintaining the efficiency of the trucking industry. Remote domiciles are used to reposition drivers to keep them near their domicile. The method assigns drivers to particular routes based on a myriad of factors and the assignment can be modified based on unforeseen circumstances.

### CROSS REFERENCE TO RELATED APPLICATIONS

Not Applicable

### STATEMENT REGARDING FEDERALLY SPONSORED RESEARCH OR DEVELOPMENT

Not Applicable

### FIELD OF INVENTION

The present invention relates to the field of the assignment and scheduling of drivers for long-haul trucking routes. Specifically, the present invention relates to the method for assigning drivers to segments of routes to maximize efficiency for a trucking company while improving the quality of life for the drivers. The present invention also relates to the management and configuration of resources, namely, truck driver personnel, to keep each driver within a close proximity to his or her domicile.

### BACKGROUND OF THE INVENTION

Trucking fleets move shipments not only locally but across the country. The moves are classified as either “short-haul” or “long-haul” depending on the distance of the route associated with the shipment. A short-haul move covers a local area that allows a single driver to leave and return to his domicile within a consecutive twelve hour time span. A long-haul move covers an area requiring the driver to drive more than eleven hours or stay on duty for more than fourteen hours. The long-haul move does not allow the driver to return to his domicile in a single day. Instead, the driver must take a layover break in accordance with the United States Department of Transportation rules and regulations.

Trucking fleets incur significant expense for long-haul drivers. The salary for a long-haul driver is typically higher than one for a short-haul driver. Trucks are usually wedded to the long haul drivers and the trucks are out of service when the drivers take their requisite breaks. The trucks that are driven may be “sleeper-trucks” which contain a bed for the driver. Costs are also incurred for meals, lodging and communication while the trucks and drivers are on the long-haul routes. Overtime is a factored in expense since long-haul drivers often cannot complete their routes in fifty-two hours or less per week. Trucking fleets also incur a high turnover rate for “long-haul” drivers because of factors such as extended periods away from home and unpredictable schedules, which results in higher recruitment and training costs.

Currently trucking fleets utilize either a single driver or a two-man team of drivers for the long-haul routes. For either scenario, the driver is governed by the stringent rules and regulations promulgated by the United States Department of Transportation. The trip time is determined by the amount of driving either one driver (or the team of two drivers) can do at any given time. This driving time impacts the transit time of the goods being transported. The transit time for the shipment is longer and the truck remains idle for lengthy periods of time to operate in accordance with the trucking driving time regulations. The number of mandatory layovers is increased the longer the route is. Thus, there is a need for a method of scheduling the drivers which minimizes the transit times of shipments being driven while also optimizing the driving times and distances the drivers can drive under the United States Department of Transportation rules and regulations. The two-man driving team was developed to meet this need. However, a two-man driving team is more expensive than a single driver and it becomes difficult to find drivers that are willing to travel together for long periods of time. The drivers are required to share among other things, a bed in the sleeper. For most drivers, this is not the optimal situation.

Tracking and scheduling methods have been patented in other industries but not in the area of truck drivers and in the trucking industry. U.S. Pat. No. 6,803,854 “System and Method for Especially Graphically Monitoring and/or Remote Controlling Stationary and/or Mobile Devices” discloses a method for monitoring the movement of objects. U.S. Pat. No. 7,102,564 “System and Method for Determining Freight Container Locations” tracks the location of containers in a freight yard. And, U.S. Pat. No. 6,058,176 “Method of and System for Terminating Calls to Selected Trunk Group Members” discloses a process for routing calls.

In the prior inventions and methods, the driver assignment and scheduling for the long-haul route are dependent upon one or two persons completing the entire round trip from his domicile to the assigned location(s), and then back to his domicile. In an industry where long-haul driver turnover is high, the number of drivers is becoming scarce and maximizing profit is a major concern, the prior inventions and methods only rely on one or two drivers to complete the route. The capital expense of sleeper trucks is much higher than trucks that do not have sleeper cabs.

The present invention is distinguished over the prior art in general and these patents in particular by designing a method that incorporates the trucking fleet's needs of servicing “long-haul” routes while maximizing the efficiency of the trucking fleet's transit time for the shipments. The present invention also allows for a better schedule for the drivers to allow them to stay in closer proximity to their domicile. The present invention gives the trucks the ability to remain idle at a remote domicile while the driver is pursuing other routes.

### SUMMARY OF THE INVENTION

It is therefore an object of this invention to provide a method of improving capital asset utilization rate for long-haul routes, which minimizes the capital investment required.

It is another object of this invention to provide a method to reduce driver turnover rates, which minimizes driver recruitment and training costs.

It is another object of this invention to provide a method for reducing the cost of long-haul driver wages while also reducing layover, detention, overtime and other costs associated with the long-haul routes.

It is another object of this invention to provide a method for reducing transit times associated with the long-haul routes.

It is another object of this invention to provide a method for improving non-monetary conditions for drivers that engage in long-haul routes to encourage employment in the trucking fleet industry.

It is another object of this invention to provide a method for minimizing empty mileage associated with long-haul routes.

It is another object of the invention to minimize driver repositioning costs.

It is another object of the invention to separate truck or tractor repositioning from driver repositioning.

It is another object of the invention to reduce capital expenses.

It is another object of this invention to improve the economy in depressed areas by creating a demand for drivers in all regions of the network.

Still another object of the invention is to provide a method to improve the profitability of trucking fleets in the long-haul industry.

### BRIEF DESCRIPTION OF THE DRAWINGS

Further objects of this invention, together with additional features contributing thereto, and advantages accruing there from, will be apparent from the following description of the preferred embodiment of the invention when read in conjunction with the accompanying drawings wherein:

FIG. 1 is block diagram of a long haul route schedule according to the preferred embodiment of the present invention.

FIG. 2 is a block diagram of the assignment of drivers to a long haul route according to the preferred embodiment of the present invention.

FIG. 3 is a schematic illustration of the basic structure of a long haul route schedule according to the preferred embodiment of the present invention.

FIG. 4 is a schematic illustration relating to the structure of a long haul route schedule with a repositioning of drivers according to the preferred embodiment of the present invention.

FIG. 5 is a schematic illustration relating to the structure of a long haul route schedule with a repositioning of drivers according to the preferred embodiment of the present invention.

FIG. 6 is a block diagram of the re-assignment of drivers when a modification is made according to the preferred embodiment of the present invention.

### DETAILED DESCRIPTION OF THE DRAWINGS

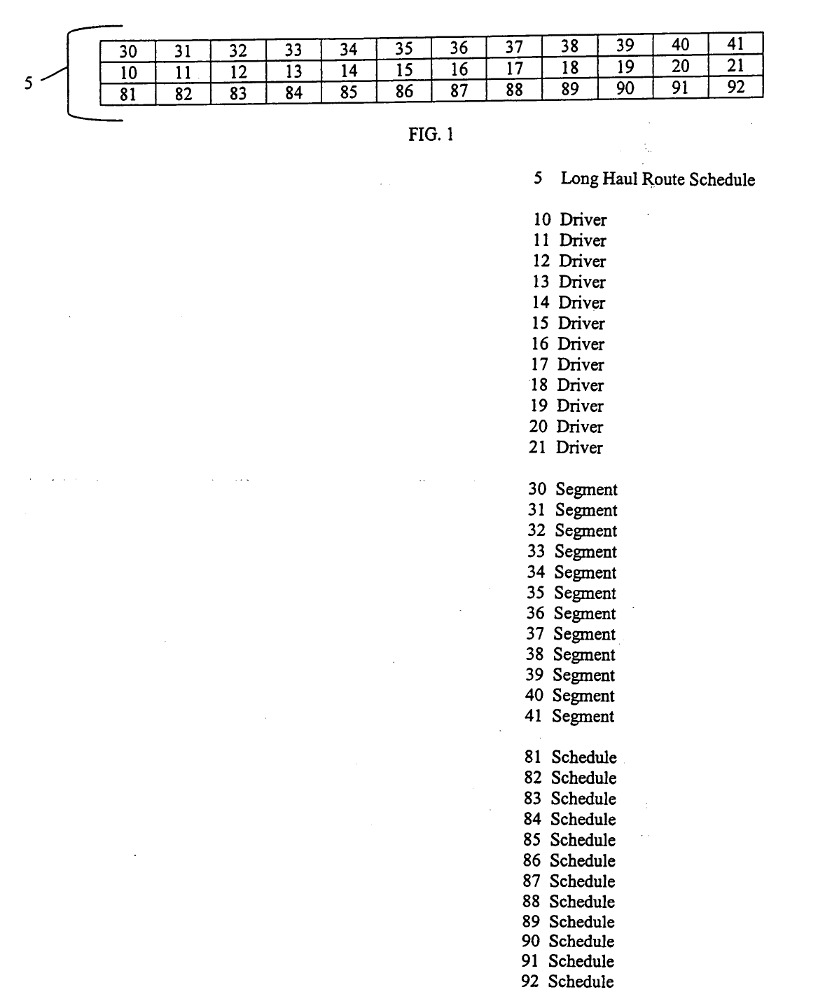

FIG. 1 shows a block diagram of a long haul route schedule 5 in a network according to the present invention. The long haul route in FIG. 1 is composed of 12 segments 30, 31, 32, 33, 34 35, 36, 37, 38, 39, 40, 41. Each segment 30, 31, 32, 33, 34 35, 36, 37, 38, 39, 40, 41 represents the distance and/or approximate time that each driver 10, 11, 12, 13, 14, 15, 16, 17, 18, 19, 20, 21 is assigned for his respective segment 30, 31, 32, 33, 34 35, 36, 37, 38, 39, 40, 41 of the route. A person of ordinary skill in the art will recognize that, depending upon the particular long haul route schedule 5, the length and/or duration of each segment 30, 31, 32, 33, 34 35, 36, 37, 38, 39, 40, 41 may vary. Each segment 30, 31, 32, 33, 34 35, 36, 37, 38, 39, 40, 41 does not need to be exactly the same driving time or distance. Each driver 10, 11, 12, 13, 14, 15, 16, 17, 18, 19, 20, 21 is assigned to a respective segment 30, 31, 32, 33, 34 35, 36, 37, 38, 39, 40, 41. For example, Driver 10 may be assigned to Segment 30. Segment 30 would be close proximity, within 50 miles, to Driver 10's domicile. A person of ordinary skill in the art will recognize that, depending on the number of segments 30, 31, 32, 33, 34 35, 36, 37, 38, 39, 40, 41 for the long haul route schedule 5, the number of drivers 10, 11, 12, 13, 14, 15, 16, 17, 18, 19, 20, 21 may vary. The number of drivers 10, 11, 12, 13, 14, 15, 16, 17, 18, 19, 20, 21 will equal the number of segments 30, 31, 32, 33, 34 35, 36, 37, 38, 39, 40, 41 for each long haul scheduling route 5. However, a driver 10, 11, 12, 13, 14, 15, 16, 17, 18, 19, 20, 21 may be assigned to more than one segment 30, 31, 32, 33, 34 35, 36, 37, 38, 39, 40, 41 for any given long haul route schedule 5. Each driver 10, 11, 12, 13, 14, 15, 16, 17, 18, 19, 20, 21 is assigned a schedule 81, 82, 83, 84, 85, 86, 87, 88, 89, 90, 91, 92 representing the time of day he is to drive his respective segment 30, 31, 32, 33, 34 35, 36, 37, 38, 39, 40, 41. For example, Driver 10, driving segment 30, may be assigned the hours of 5 a.m. to 10 a.m. for his schedule 81. Driver 11, driving segment 31, need not be assigned his schedule 82 that is continuous in time to driver 10's schedule 81. Driver 11, for driving segment 31, may be assigned the schedule 82 from 1:00 p.m. to 4:00 p.m. A person of ordinary skill in the art will recognize that the schedules 81, 82, 83, 84, 85, 86, 87, 88, 89, 90, 91, 92 will reflect a period of time equal to the respective segments 30, 31, 32, 33, 34 35, 36, 37, 38, 39, 40, 41. A person of ordinary skill in the art will also recognize that while the schedules 81, 82, 83, 84, 85, 86, 87, 88, 89, 90, 91, 92 flow on a continuum representing a progression in time and date, the schedules 81, 82, 83, 84, 85, 86, 87, 88, 89, 90, 91, 92 do not need to be consecutive in nature. There are many ways that FIG. 1 could be modified depending on circumstances without varying from the principles of the present invention.

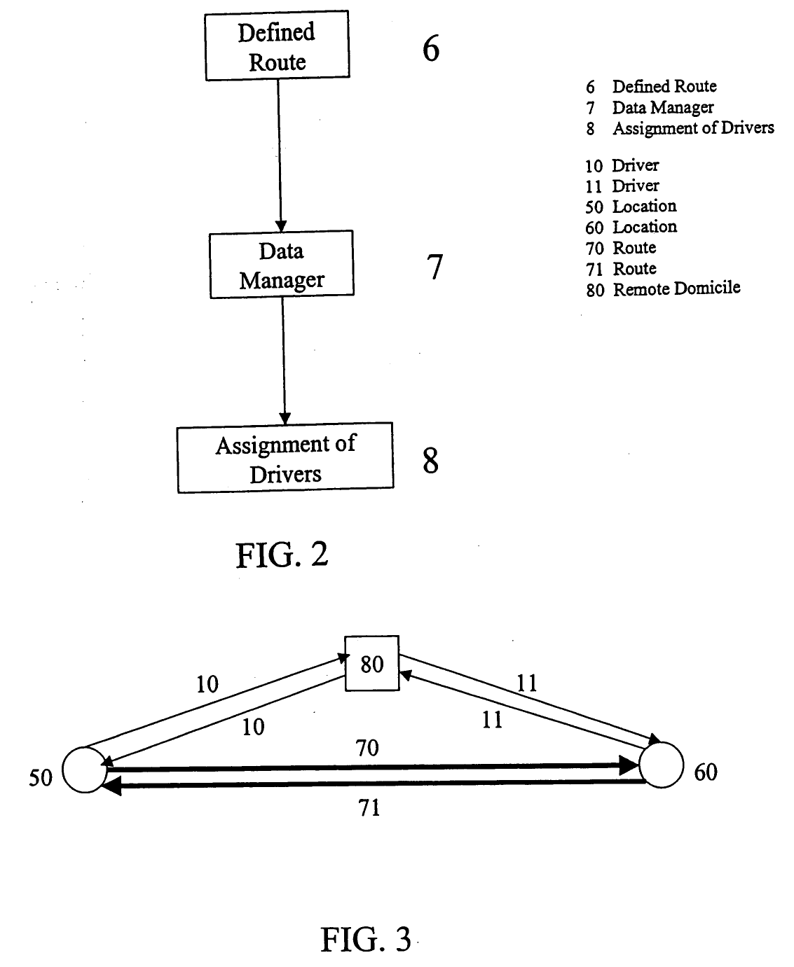

FIG. 2 depicts a block diagram of the assignment of drivers to a long haul route schedule 5. The defined route 6 for each pick up and delivery, service call or any other type of movement required as requested by the client is determined on an on-going basis. To achieve the defined route 6 for each load, an analysis is done for each load to determine the feasible paths for the defined route 6 depending on the client's needs of when the load needs to be picked up and delivered to the final location. All loads are then analyzed to create a balanced network with balanced segments 30, 31, 32, 33, 34 35, 36, 37, 38, 39, 40, 41 while optimizing the network of the defined routes 6, which in turn creates an optimal expenditure of resources for all entities involved. An analysis is done of all available remote domiciles 80 to determine designated locations for the drivers 10, 11, 12, 13, 14, 15, 16, 17, 18, 19, 20, 21 to pass off the truck from one driver (i.e. Driver 10) to another (i.e. Driver 11). The truck, which could include the tractor and the trailer, or the tractor may be passed off at the remote domicile 80. A remote domicile 80 is a designated location for the drivers 10, 11, 12, 13, 14, 15, 16, 17, 18, 19, 20, 21 to transition and shift the transit of the goods. The location of the remote domiciles 80 may vary depending on the paths of the routes 6. While remote domiciles 80 may be established, as the need arises new remote domiciles 80 may be determined. One of ordinary skill in the art will recognize that remote domiciles 80 can include a company-owned location, a distribution center, a warehouse, a plant, a break-bulk location, a carrier yard, a truck stop, a rest area or any other location where the truck is passed off from one driver 10 to another 11. Driver 10 is not required to be at the location when Driver 11 receives the truck. The location of the remote domiciles 80 vary to balance the long haul route schedules 5 so that each driver does not exceed the number of hours regulated by the United States Department of Transportation. One of ordinary skill in the art will recognize that more than one remote domicile 80 may exist given the number of the trucks that need to be routed at a given time period. Trucks may sit idle at the remote domiciles 80 because of various factors, such as the delivery of the truck may not be required at the time the truck arrives at the remote domicile 80 so the next driver is not needed to drive the truck to its final location immediately upon receipt at the remote domicile 80. For each load, an output of the defined route 6 is determined based upon the optimal path and schedule of each segment 30, 31, 32, 33, 34 35, 36, 37, 38, 39, 40, 41. Once the defined route 6 is determined, the data manager 7 processes the assignment factors to assign drivers to the segments of the defined route 6. The data manager 7 uses a handwritten technique or computer technology such as a software, hardware or database stored in an electronic form that processes the following assignment factors. These assignment factors include determining the schedules for the drivers, determining the number of drivers needed for the route, determining the specific driver needed for each segment of the route, determining the availability of equipment, determining the number of remote domiciles 80 that the truck will go through, determining the location of the remote domiciles 80, determining the feasibility of the routing options, determining the number of hours each driver is available to drive according to the United States Department of Transportation Regulations, determining the skill required of the driver to drive the particular truck, factoring in the customer relationship with the drivers. One of ordinary skill in the art will recognize that more assignment factors may be utilized. One of ordinary skill in the art will also recognize that the data manager 7 may be in any medium which can compute said assignment factors. Once the data manager 7 has processed the assignment factors, the data manager creates an assignment 8 of drivers 10, 11, 12, 13, 14, 15, 16, 17, 18, 19, 20, 21 to their respective driving segments 30, 31, 32, 33, 34 35, 36, 37, 38, 39, 40, 41. The driver is given his route through a form of communication device. He may be told his route by means of a person or a computerized device. One of ordinary skill in the art will recognize that other forms of communication devices may be used. A driver (i.e. Driver 10) may be assigned 8 to more than one defined routes 6 in any given time period. This assignment 8 of drivers to multiple route segments helps keep the network balanced network while keeping the driving time of the driver (ie. Driver 10) within the driving times as regulated by the United States Department of Transportation. The network remains balanced when the assignment 8 of drivers can be utilized to redistribute drivers where they may be needed to prevent a shortage of drivers in one area or a surplus of drivers in another area. A driver could also be assigned to reposition the truck, the tractor or the tractor and trailer to maintain a balanced network.

FIG. 3 depicts the schematic of a two-driver (10 and 11) route, where each driver will pick up a truck at one location and drop off another truck at the same location. The truck that is being picked up at Location 50 is being delivered to Location 60 via the route 70. The truck that is being picked up at Location 60 is being delivered to Location 50 via the route 71. Driver 10's domicile is in close proximity to Location 50. Driver 11's domicile is in close proximity to Location 60. Driver 10 leaves Location 50 and follows the route 70 to the remote domicile 80. The remote domicile 80 was derived from the long haul route schedule 5 in FIG. 1 through the defined route 6 in FIG. 2. Driver 10 and Driver 11 exchange trucks at the remote domicile 80. Driver 10 does not have to arrive at remote domicile 80 at the same time Driver 11 does. Driver 10 drives the newly-acquired truck, from Driver 11, back along the route 71 to Location 50. Driver 11 drives the newly-acquired truck, from Driver 10, back along the route 70 to Location 60. Drivers 10 and 11 are able to return to their respective domiciles where they operate their respective trucks within the time mandated by the United States Department of Transportation, without the drivers having to take a mandatory and lengthy break.

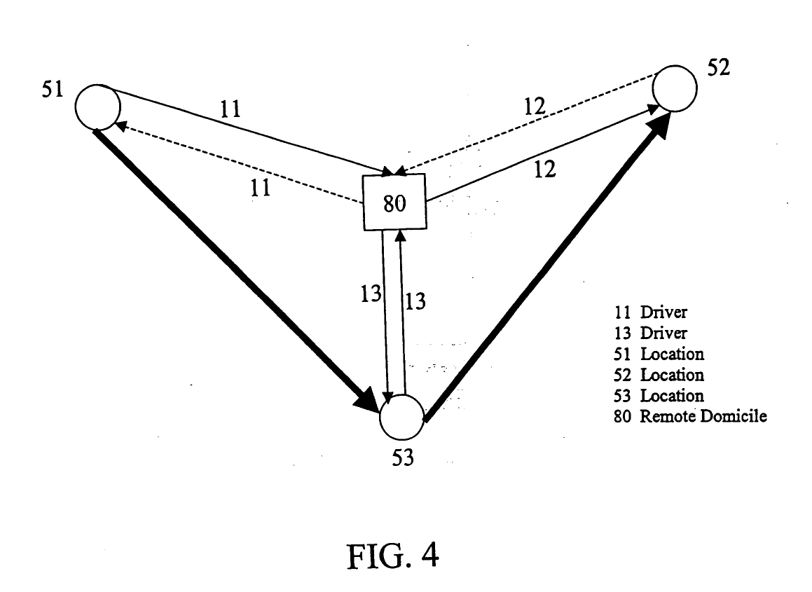

FIG. 4 depicts the schematics of a long haul route where drivers 11, 12 and 13 may need to be repositioned in an under-balanced network. The truck that is being picked up at Location 51 is being delivered to Location 53. The truck that is being picked up at Location 53 is being delivered to Location 52. Driver 11 picks the truck up at Location 51 and drives it to remote domicile 80. Driver 13 picks the truck up at Location 53 and drives it to remote domicile 80. Driver 12 is domiciled at remote domicile 80. The arrival times and departure times of Drivers 11, 12 and 13 at remote domicile 80 need not be at the same times. The network configuration does not provide that the trucks must be picked up immediately upon their drop off at a remote domicile 80. Instead, the model factors in a lag time where a truck may sit at the remote domicile 80 while waiting for its next driver to take it to its next location. The configuration is dependent on the model in FIG. 2. The truck that Driver 11 drove to remote domicile 80 from Location 51 is passed off to Driver 13 who drives the truck on to Location 53. The truck that Driver 13 drove to remote domicile 80 from Location 53 is passed to Driver 12 who drives the truck on to Location 52. Drivers 11 and 12 do not have segments assigned to return them from their current locations back to their respective domiciles; however, both Drivers 11 and 12 need to be repositioned back to their respective domiciles. They could return by means of a rental vehicle, company owned vehicle or could ride with another driver if that driver was passing through the domicile destination. A person of ordinary skill in the art will recognize that other means to get from the drivers current locations to their respective domiciles may exist. This driving time to return from these locations to their domiciles is not considered on-duty time in accordance with the United States Department of Transportation because neither of these drivers 11 or 12 are driving commercial vehicles. When the trucks are passed off at the remote domicile 80, an authentication process must be in place to ensure the safety of the trucks and the goods that are en route to their final location. The need for an authentication process arises because the drivers may not be present at the same time when the trucks are passed off at the remote domicile 80. The trucks are said to be in idle mode because they are sitting at the remote domicile 80 awaiting the next driver when the truck is needed to be moved to its next remote domicile 80 or final location. These processes could include the use of a mobile or non-mobile device so that the security is not compromised. An individual fleet may decide the authentication process or device that is best suited to its security needs.

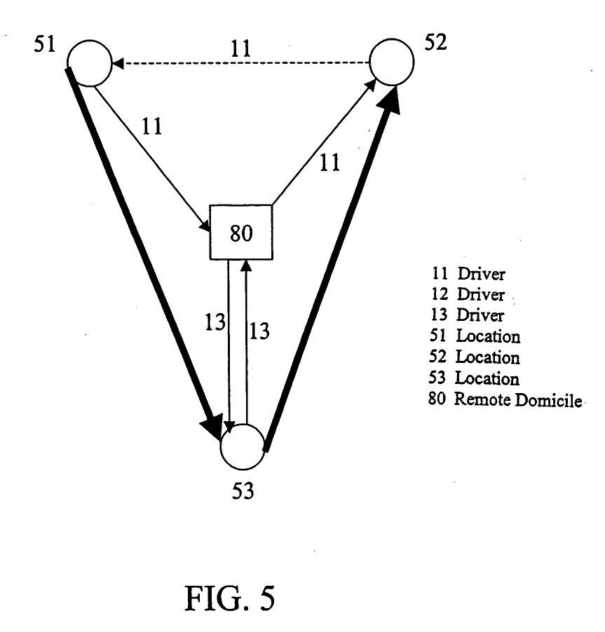

FIG. 5 shows another variation of an unbalanced network where only two drivers need to execute the shipments and only one driver needs to be repositioned. In FIG. 5, Driver 11 drives the truck from location 51 to remote domicile 80. Driver 13 drives his shipment from location 53 to remote domicile 80. The trucks are passed off at remote domicile 80. Driver 13 drives his truck that was received in the passing off on to location 53. Driver 11 drives the truck he received in the passing off on to location 52. Upon arrival at location 52, Driver 11 needs to be repositioned to his domicile at location 51. Driver 11 could drive back to Destination 51 by means of a rental car, company vehicle or other transportation that is not a commercial vehicle within the meaning of the United States Department of Transportation regulations.

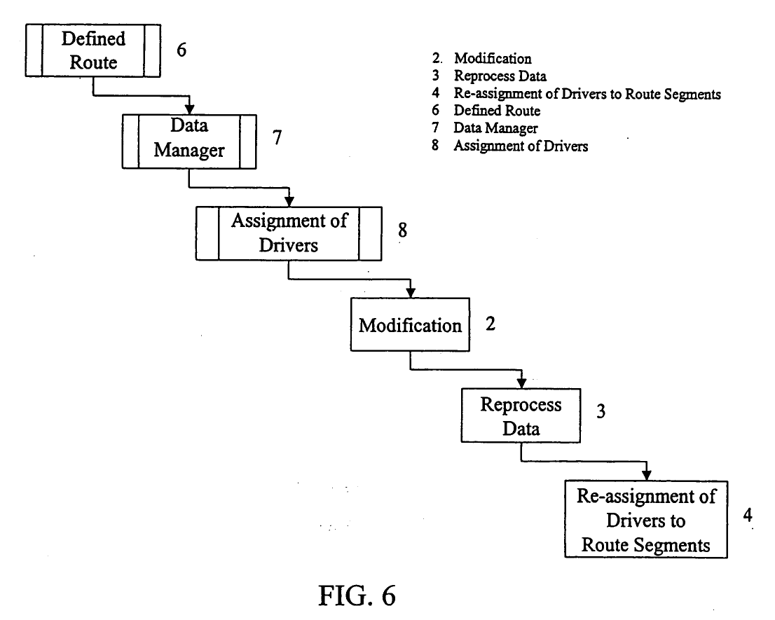

Drivers may need to be re-assigned segments based on the addition of routes that were not anticipated or unplanned events that arise after the assignment 8 has been communicated to the drivers. FIG. 6 anticipates that a modification 2 may need to be made to the assignment 8 of drivers that was set forth in the diagram in FIG. 2. The data manager 7 will reprocess the data 3 based on the current and available criteria like the data manger 7 did in FIG. 2. The drivers may then be re-assigned 4 to different segment(s) and/or different route(s). The modification 2 may cause a driver's entire schedule to be revised. The driver is kept apprised of any modifications 2 that are made to his segment 30 of a long haul route schedule 5 via the communication device. Locations 51, 52 and/or 53 may also be remote domiciles for other routes even though they are origin and destination points on the long haul route schedule 5.

While the invention has been shown, described and illustrated in detail with reference to the preferred embodiment, and possible modifications thereof, it will be understood by those skilled in the art that equivalent changes in form and detail may be made therein without departing from the true spirit and scope of the invention as claimed. For example, the number of schedules, drivers, or segments could vary, and the length of segments could vary, from case to case. It is the inventor's intent to capture all such modifications that operate within the principles of the present invention as an advantage over the single and team-based approaches to long haul driving of the prior art.

I claim:

1. A method for assigning drivers to schedules for long haul routes comprising, in no particular order, the following steps:
(a) determining a route to transport at least one truck from a first location to a second location;
(b) dividing said route into segments;
(c) using a data manager to assign at least one driver to at least one segment of said route;
(d) assigning a time period during which said at least one driver is to drive said segment of said route;
(e) using said data manager to assign said at least one driver to drive said truck to at least one remote domicile along said segment of said route;
(f) authenticating said truck or its cargo at said remote domicile;
whereupon, reaching said remote domicile at the end of said segment of said route, said driver returns to said driver's local domicile without said truck.

2. The method according to claim 1, wherein said driver remains in close proximity to his domicile.

3. The method according to claim 1, wherein said driver receives a schedule by reading a communication device.

4. A method for modifying a driver assignment for a long haul route comprising, in no particular order, the following steps:
(a) determining a route to transport at least one truck from a beginning location to a final location;
(b) dividing said route into segments;
(c) using the data manager to assign at least one driver to at least one remote domicile along at least one of said segments of said route;
(d) assigning a time period for said driver to drive said segment of said route;
(e) using the data manager to assign said driver to at least one remote domicile along said segment of said route;
whereupon, when an intervening factor occurs defeating the achievement of any of the foregoing assignments, the following steps occur, in no particular order:
(f) reprocessing data to re-assign said driver to a second route or a second segment of said second route.
(g) using the data manager to assign said driver to at least a second remote domicile along said second route or said second segment;
(h) authenticating a truck or its cargo at said second remote domicile;

5. The method according to claim 4, wherein said driver remains in close proximity to his domicile.

6. The method according to claim 4, wherein said driver receives his schedule through a communication device.

7. A method for route optimization of one or more long haul routes using multiple drivers per route, at least one route, multiple route segments for each said route, and at least one truck per route, comprising, in no particular order, the following steps:
(a) assigning a first driver to a first truck, based in whole or in part on the proximity of said driver's domicile to the starting location of each said route segment;
(b) estimating the time it should take a driver to complete each of said route segments, and based upon said estimating step, employing enough of said route segments in each said route so that no route segment should require any of said drivers to drive more than five and a half hours in order to reach a point of remote domicile at the end of each said segment; and
(c) where the completion of each said route segment does not complete said route, coordinating the completion of each said route segment with the initiation of a next route segment by assigning a second driver to said first truck, where said assigning of said second driver is based, in whole or in part, on the proximity of said second driver's domicile to the starting location of said next route segment; and
(d) requiring said second driver to authenticate the start of said next route segment by one or more of the following steps (1) reporting said second driver's identification; (2) reporting the identification or location of said first truck; or (3) reporting one or more indications of the status or type of the cargo being carried by said first truck.
